(19) United States
(12) Patent Application Publication
(10) Pub. No.: US 2012/0173390 A1
(43) Pub. Date: Jul. 5, 2012

(54) SINGLE, MIXED-VIEW PRESENTATION OF RELATED PRODUCTS

(75) Inventor: LAWRENCE LAM, Bellevue, WA (US)

(73) Assignee: MICROSOFT CORPORATION, Redmond, WA (US)

(21) Appl. No.: 12/980,955

(22) Filed: Dec. 29, 2010

(51) Int. Cl. G06Q 30/00

(52) U.S. Cl. 705/27.2

(57) ABSTRACT

Methods and systems for presenting related products in a single, mixed-view display are provided. Upon receiving an indication of a focal product, a plurality of ontological relationships of the focal product is identified or determined, each identified ontological relationship including one or more additional products associated therewith, A single-view display is presented that includes an indicator of the product of interest and product indicators for at least a portion of the additional products associated with at least two of the plurality of ontological relationships. Generally, the additional product-indicators are arranged around the indicator of the focal product. In this way, the user is presented with a product of interest, as well as other products having a variety of relationships with respect to the product of interest in a single, seamless view.

### BACKGROUND

When viewing online information associated with a product, it is often beneficial to users to also view information concerning related products, that is, product accessories, similar products, and the like. While many websites provide displays of products and/or information related by a particular ontological relationship to a product in which the user has indicated an interest, such sites do so in a compartmentalized fashion. As the number of ontological relationships a given product has increases, displaying products related by virtue of each such relationship in such a segmented fashion creates a user experience that is very difficult to navigate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things presenting related products in a single, mixed-view. Upon receiving an indication of a focal product, for instance, upon receiving user selection of a particular product indicator, a plurality of ontological relationships of the focal product are identified or determined, each identified ontological relationship including one or more additional products associated therewith. By way of example only, and not limitation, such ontological relationships may include product accessories, product replacement parts, products searched for by other users that viewed information pertaining to the same focal product, similar products (e.g., products with the same browse taxonomy), competitive products, and the like. In accordance with embodiments hereof, a single-view display is presented that includes an indicator of the product of interest and product indicators for at least a portion of the additional products associated with at least two of the plurality of ontological relationships. Generally, the additional product-indicators are arranged around the focal product indicator. In this way, the user is presented with a product of interest (i.e., the focal product), as well as other products having a variety of relationships with respect to the product of interest in a single, seamless view.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing system environment suitable for use in implementing embodiments of the present invention;

FIG. 2 is a flow diagram showing a method for presenting related products in a single, mixed-view, in accordance with embodiments of the present invention;

FIG. 3 is a flow diagram showing another method for presenting related products in a single, mixed-view, in accordance with embodiments of the present invention;

FIG. 4 is a flow diagram showing yet another method for presenting related products in a single, mixed-view upon determining whether a particular threshold criterion has been met, in accordance with embodiments of the present invention;

FIG. 5 is a flow diagram showing another method for presenting related products in a single, mixed-view upon determining whether a user has selected a different product indicator, in accordance with embodiments of the present invention;

FIG. 6 is a screen display showing an exemplary user-interface for use in presenting related products in a single, mixed-view, in accordance with an embodiment of the present invention; and

FIG. 7 is a block diagram showing an exemplary computing system environment suitable for implementing embodiments of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, presenting related products in a single, mixed-view. Upon receiving an indication of a focal product (for instance, upon receiving user selection of a particular product indicator), a plurality of ontological relationships of the focal product are identified or determined, each identified ontological relationship including one or more additional products associated therewith. By way of example only, and not limitation, such ontological relationships may include product accessories, product replacement parts, products searched for by other users that viewed information pertaining to the same focal product, similar products (e.g., products with the same browse taxonomy), competitive products, and the like. In accordance with embodiments hereof, a single-view display is presented that includes an indicator of the product of interest and product indicators for at least a portion of the additional products associated with at least two of the plurality of ontological relationships. Generally, the additional product-indicators are arranged around the indicator of the focal product. In this way, the user is presented with a product of interest (i.e., the focal product), as well as other products having a variety of relationships with respect to the product of interest in a single, seamless view.

Accordingly, in one embodiment, the present invention is directed to one or more computer-storage media having computer-executable instructions embodied thereon, that when executed, cause a computing device to perform a method for presenting related products in a single, mixed-view. The method includes receiving an indication of a focal product and identifying a plurality of ontological relationships of the focal product. The method further includes presenting a single-view display having product indicators for at least a portion of the one or more additional products associated with at least two of the plurality of ontological relationships arranged around an indicator of the focal product.

In another embodiment, the present invention is directed to a system for presenting related products in a single, mixed-view, the system comprising a computing device associated with one or more processors and one or more computer storage media, a data store coupled with the computing device, and a related-product display generating engine. The related-product display generating engine receives an indication of a focal product and identifies a plurality of ontological relationships of the focal product. Each of the plurality of ontological relationships has one or more additional products associated therewith. The related-product display generating engine further presents a single-view display having product indicators for at least a portion of the one or more additional products associated with at least two of the plurality of ontological relationships arranged around an indicator of the focal product.

In yet another embodiment, the present invention is directed to one or more computer-storage media having computer-executable instructions embodied thereon, that when executed, cause a computing device to present related products in a single, mixed-view, user-interface. The user-interface includes a focal product indicator display area that presents a product indicator for a focal product and a related product indicator display area that presents product indicators for at least a portion of additional products identified as associated with a plurality of ontological relationships of the focal product. The related product indicator display area is arranged around the focal product indicator display area. In embodiments, the user-interface further comprises a user-selectable filter display area that receives a user selection indicating for which of the plurality of ontological relationships of the focal product related product indicators are to be displayed and/or in what proportion.

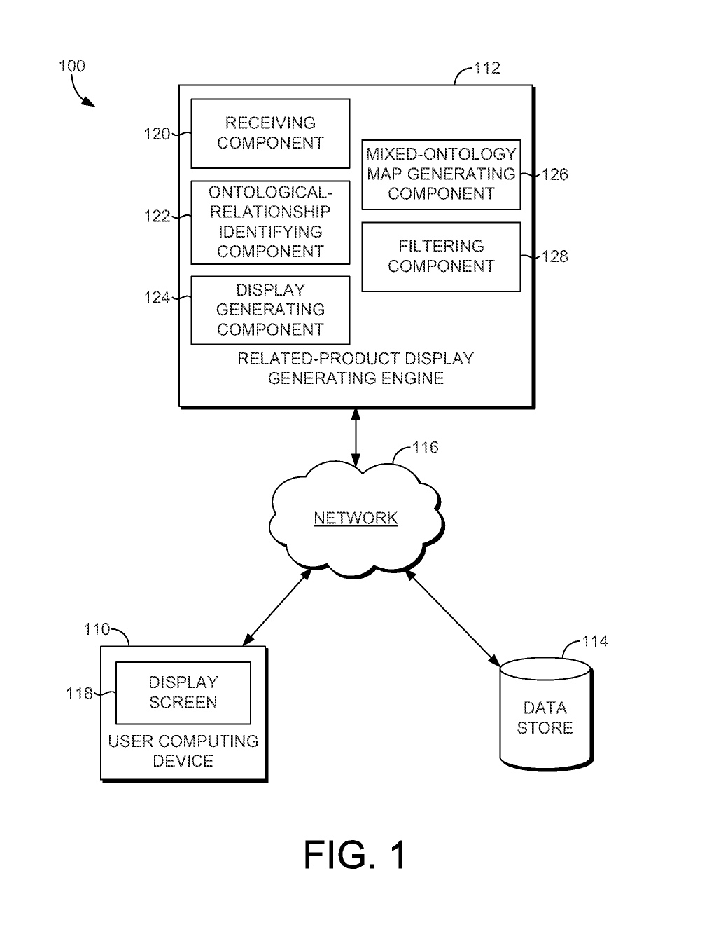

Turning now to FIG. 1, a block diagram is illustrated that shows an exemplary computing system environment 100 suitable for use in implementing embodiments of the present invention. It will be understood and appreciated by those of ordinary skill in the art that the computing system environment 100 shown in FIG. 1 is merely an example of one suitable computing system environment and is not intended to suggest any limitation as to the scope of use or functionality of embodiments of the present invention. Neither should the computing system environment 100 be interpreted as having any dependency or requirement related to any single module/component or combination of modules/components illustrated therein.

The computing system environment 100 includes an end-user computing device 110, a related-product display generating engine 112, and a data store 114, all in communication with one another via a network 116. The network 116 may include, without limitation, one or more local area networks (LANs) and/or wide area networks (WANs). Such networking environments are commonplace in offices, enterprise-wide computer networks, intranets and the Internet. Accordingly, the network 116 is not further described herein.

In some embodiments, one or more of the illustrated components/modules may be implemented as stand-alone applications. In other embodiments, one or more of the illustrated components/modules may be integrated directly into the operating system of related-product display generating engine 112 and/or the end-user computing device 110. It will be understood by those of ordinary skill in the art that the components/modules illustrated in FIG. 1 are exemplary in nature and in number and should not be construed as limiting. Any number of components/modules ma be employed to achieve the desired functionality within the scope of embodiments hereof. Further, components/modules may be located on any number of servers or client computing devices. By way of example only, the related-product display generating engine might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 114 is configured to store information associated with products and ontological relationships. In various embodiments, such information may include, without limitation, product-specific information (including associated iconic indicators and/or product labels), product ontological relationships and associated products, ontology labels, threshold criteria for altering displays, result filter settings, and the like. In embodiments, the data store 114 is configured to be searchable for one or more of the items stored in association therewith. It will be understood and appreciated by those of ordinary skill in the art that the information stored in association with the data store 114 may be configurable and may include any information relevant to products, product ontological relationships, and/or the like. The content and volume of such information are not intended to limit the scope of embodiments of the present invention in any way. Further, though illustrated as a single, independent component, the data store 114 may, in fact, be a plurality of storage devices, for instance a database cluster, portions of which may reside on the related-product display generating engine 112, the computing device 110, another external computing device (not shown), and/or any combination thereof.

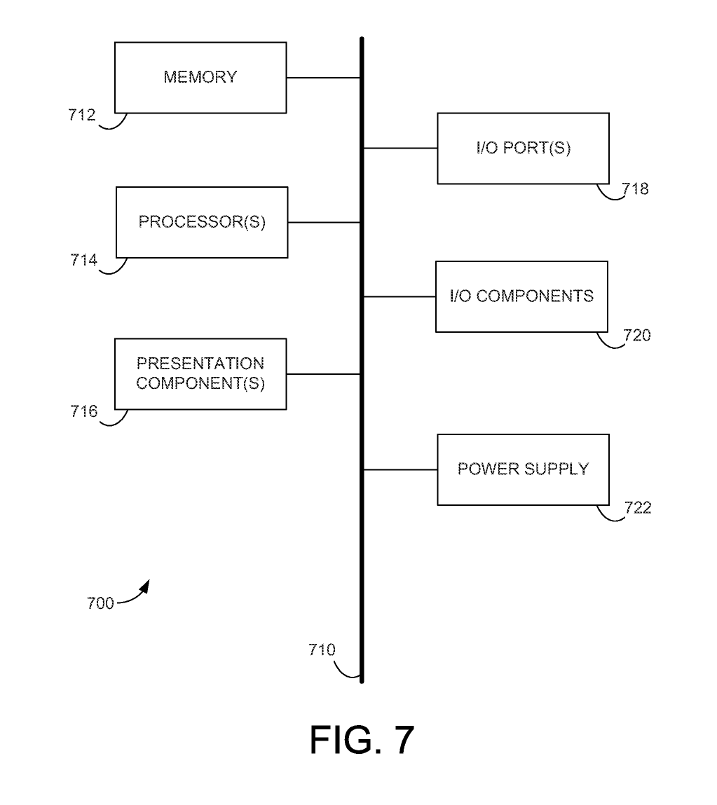

Each of the end-user computing device 110 and the related-product display generating engine 112 shown in FIG. 1 may be any type of computing device, such as, for example, computing device 700 described below with reference to FIG. 7. By way of example only and not limitation, each of the computing device 110 and the related-product display generating engine 112 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

Components of the computing device 110 and the related-product display generating engine 112 (not shown for clarity) may include, without limitation, a processing unit, internal system memory, and a suitable system bus for coupling various system components, including one or more databases for storing information (e.g., files and metadata associated therewith). Each of the computing device 110 and the related-product display generating engine 112 typically includes, or has access to, a variety of computer-readable media. By way of example, and not limitation, computer-readable media may include computer-storage media and communication media. In general, communication media enables each server to exchange data via a network, e.g., network 116. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system environment 100 is merely exemplary. While the end-user computing device 110 and the related-product display generating engine 112 are illustrated as single units, one skilled in the art will appreciate that the end-user computing device 110 and the related-product display generating engine 112 are scalable. For example, the end-user computing device 110 and/or the related-product display generating engine 112 may in actuality include a plurality of computing devices in communication with one another. Moreover, the data store 114, or portions thereof, may be included within, for instance, the related-product display generating engine 112 and/or the end-user computing device 110 as a computer-storage medium. The single unit depictions are meant for clarity, not to limit the scope of embodiments in any form.

As shown, the end-user computing device 110 includes a display screen 118. The display screen 118 is configured to display information to the user of the computing device 110, for instance, information relevant to communications initiated by and/or received by the computing device 110, product indicators, related-product indicators, and the like. Embodiments are not intended to be limited to visual display but rather may also include audio presentation, combined audio/visual presentation, and the like.

As shown in FIG. 1, the related-product display generating engine includes a receiving component 120, an ontological relationship identifying component 122, a display generating component 124, a mixed-ontology map generating component 126 and a filtering component 128. In some embodiments, one or more of the components 120, 122, 124, 126 and 128 may be implemented as stand-alone applications. In other embodiments, one or more of the components 120, 122, 124, 126 and 128 may be integrated directly into the operating system of the end-user computing device 110. It will be understood by those of ordinary skill in the art that the components 120, 122, 124, 126 and 128 illustrated in FIG. 1 are exemplary in nature and in number and should not be construed as limiting. Any number of components may be employed to achieve the desired functionality within the scope of embodiments hereof.

The receiving component 120 is configured to receive (via the network 116) an indication of a focal product (for instance, upon receiving user selection of a particular product indicator presented on the display screen 118 of the end-user computing device 110). Generally, a focal product is a product of interest to the user of the end-user computing device 110. For instance, imagine that a user is interested in purchasing a digital camera. Accordingly, s/he conducts a search (e.g., via an Internet search engine) for “digital cameras.” Further imagine that upon having results presented that satisfy the search request, the user selects a particular result featuring a digital camera manufactured by Company ABC utilizing the end-user computing device 110. In this instance, the Company ABC digital camera is the focal product and the user's selection thereof is received (via network 116) by the receiving component 120 of the related-product display generating engine 112, such selection serving to initiate presentation of a focal product indicator and related products in a single, mixed-view in accordance with embodiments of the present invention, as more fully described below.

The ontological relationship identifying component 122 is configured to receive an indication of a focal product from the receiving component 120 and to identify ontological relationship of the focal product. As utilized herein, “ontological relationships” are explicit formal specifications of how to represent products of interest and the relationships that various products hold among them. Thus, by way of example only and not limitation, ontological relationship in accordance with embodiments hereof may include product accessories, product replacement parts, products searched for by other users that viewed information pertaining to the same focal product, similar products (e.g., products with the same browse taxonomy), competitive products, and the like. Each ontological relationship identified by the ontological relationship identifying component 122 includes at least one additional product associated therewith. That is, each ontological relationship identified by the ontological relationship identifying component 122 includes at least one product associated therewith that is not the focal product.

In embodiments, the ontological relationship identifying component 122 is configured to query the data store 114 (via network 116) for the desired ontological relationship information. In other embodiments, the ontological relationship identifying component 122 is configured to generate ontological relationships of the focal product. Any and all such variations, and any combination thereof, are contemplated to be within the scope of embodiments of the present invention.

The display generating component 124 is configured to receive an indication of the focal product and ontological relationship information from the ontological relationship identifying component 122 and to generate a single-view display having product indicators for at least a portion of the one or more additional products and an indicator of the focal product. In this regard, the display generating component 124 is configured to determine which of the plurality of ontological relationships for which to display additional product indicators and to determine which additional product indicators associated with each determined ontological relationship to present. In embodiments, the display generating component 124 is configured to query the data store 114 (via network 116) for the desired information. In other embodiments, the ontological relationship identifying component 122 is configured to determine which of the plurality of ontological relationships for which to display additional product indicators and to determine which additional product indicators associated with each determined ontological relationship to present and to transmit the determined information to the display generating component 124 for display generation. Any and all such variations, and any combination thereof, are contemplated to be within the scope of embodiments of the present invention.

In accordance with embodiments hereof, the single, mixed-view display is generated so that the focal product indicator is situated on the display such that the product indicators for any additional products are arranged around it. For instance, the focal product indicator may be situated in a central location on the display with product indicators for a plurality of additional products surrounding the focal product indicator. It will be understood and appreciated by those of ordinary skill in the art that use of the term “around” is not intended to limit the present invention to embodiments having related-product indicators surrounding a focal product indicator by a full 360°. Rather, “around” is simply meant to illustrate that the focal product remains just that—the focal point of a single-view display. The focal product indicator may be shown of a larger size, highlighted, bolded, etc. with the related-product indicators being arranged in any fashion with respect thereto such that a single-view is maintained, and such that the focal product indicator remains the item on the display that most strongly attracts the user's attention. Any and all such variations, and any combination thereof, are contemplated to be within the scope of embodiments of the present invention.

Generally, a particular focal product has numerous ontological relationships associated with it, and each of the ontological relationships has a plurality of associated additional products. As such, each single-view display contains product indicators for only a portion of the identified additional products. In embodiments, at least one additional product indicator for at least two ontological relationships is presented in association with the focal product indicator, such that at least three total product indicators are presented in the single-view display. It will be understood and appreciated by those of ordinary skill in the art, however, that the number and nature of additional product indicators displayed is not meant to limit the scope of embodiments of the present invention in any way.

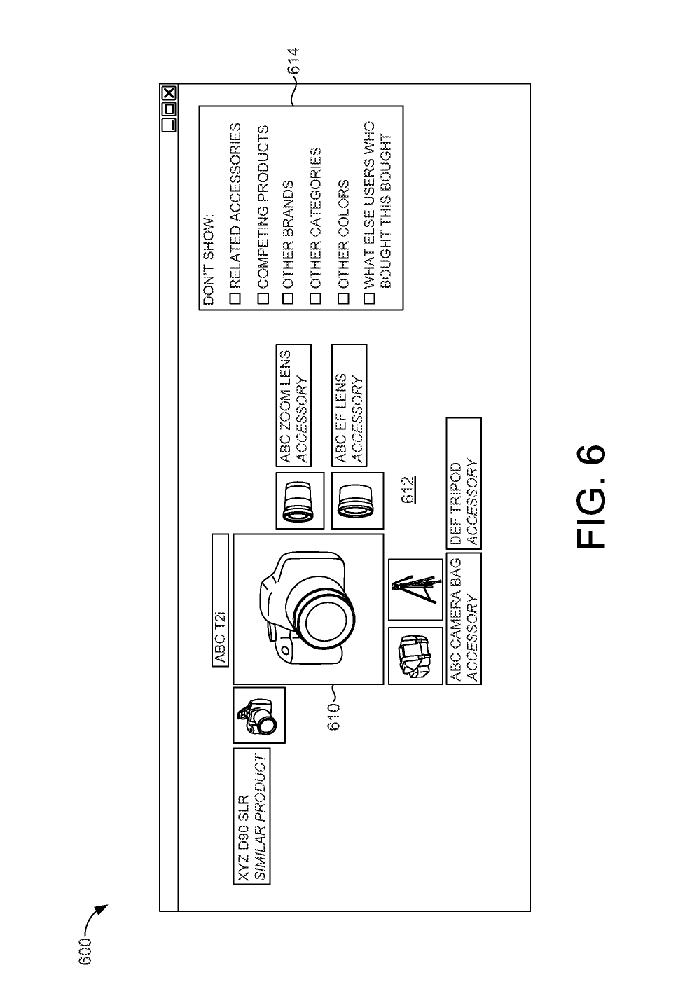

Returning to the above example wherein a user conducted a search for “digital cameras” and then selected a particular result featuring a digital camera manufactured by Company ABC, the display generating component 124 may be configured to generate a single-view display having product indicators for products associated with the ontological relationships “product accessories” and “similar products” surrounding an indicator for the digital camera manufactured by Company ABC. Such an embodiment is more fully described below with reference to FIG. 6. The display generating component 124 is further configured to transmit the generated display (via network 116) to the end-user computing device 110 for presentation in association with the display screen 118.

In embodiments, once a single, mixed-view display has been presented to the user, the related-product indicators and associated information presented may be changed—with or without being initiated by user interaction. For instance, upon determining that a certain threshold criterion has been met (e.g., a set period of time has passed since the single, mixed-view display was presented), the presented related-product indicators (and/or associated information) may change such that a new product indicator is displayed in place of a previously-presented product indicator. In accordance with embodiments hereof, such new product indicators may belong to the same ontological relationship as the previously-presented product indicator or may be of the focal product by way of a different ontological relationship. In this regard, the display generating component 124 (and/or the filtering component 128, as more fully described below) may be configured to determine whether a threshold criterion has been met and to alter the single, mixed-view display upon determining that it has.

Or, upon receiving a user-selection of one of the additional-product product indicators (for instance, upon receiving—via the receiving component 120—a user selection of a presented indicator for a product accessory to the focal product), the single, mixed-view display may change such that the selected additional-product product indicator becomes a new focal product. In this way, products of the new focal product by various ontological relationships may be presented around the new focal product indicator. As the new focal product is related via at least one ontology relationship to the previous focal product, some or the entire group of additional-product product indicators displayed in association with the new focal product may change with respect to what was presented around the previous focal product. In this regard, the display generating component 124 may be configured to receive user input from the receiving component 120 and alter the single, mixed-view display in accordance therewith.

The mixed-ontology map generating component 126 is configured to receive ontological relationship information from the ontological relationship identifying component 122, the ontological relationship information related to a plurality of additional products from a plurality of different ontological relationships, and to combine the ontological relationship information into a single, mixed-ontology map. That is, the mixed-ontology map generating component 126 is configured to assimilate and combine the information associated with a number of separate ontological relationships (and products belonging thereto) into a single mixed-ontology map. In this way, a single map may be queried and/or referenced for generation of each single, mixed-view display related to a particular focal product. In embodiments, an indication or ontology-relationship label indicating the original ontological relationship of particular additional products to the focal product is preserved in the mixed-ontology map, although such information may or may not be presented to the user.

Thus, the mixed-ontology map generating component 126 is further configured to transmit the single, mixed-view map to the display generating component 124 for generation of a single, mixed-view display (and, similarly, the display generating component 124 is further configured to receive single, mixed-ontology maps from the mixed-ontology map generating component 126). In such embodiments, the display generating component 124 is configured to generate a display comprising at least a portion (and generally less than the whole) of the information on a single, mixed-ontology map in a single, mixed-view display. It should be noted that while configured to accept information from both the ontological relationship identifying component 122 and the mixed-ontology map generating component 126, the display generating component 124 will generally accept information related to a particular desired mixed-view from one of these two sources.

In embodiments of the present invention, users are presented with the ability to control with which of a plurality of ontological relationships, additional product indicators will be presented and/or in what proportions. Such ability may be presented to the user by way of a user-preference selection independent of the single-view display and/or in association with the single-view display, as shown in FIG. 6, more fully described below. By way of example, a user may indicate s/he desire to see indications of product accessories but not competitive products. Or, in another embodiment, a user may indicate that s/he desires to be presented with 60% product accessories, 20% competitive products and 20% products having the same browse taxonomy as a focal product. Thus, the filtering component 128 of the related-product display generating engine 112 is configured to receive additional product ontological relationship information (e.g., from the ontological relationship identifying component 122 and/or the mixed-ontology map generating component 126) and to receive user-customizable filter information (e.g., from the end-user computing device 110) and to filter such information according to user-customized filter selections. The filtered information is then transmitted to the display generating component 124 for generation of a single, mixed-view display of the filtered product information. In other embodiments, standard filtering mechanisms that do not permit user customization may be utilized. Any and all such variations, and any combination thereof, are contemplated to be within the scope of embodiments of the present invention.

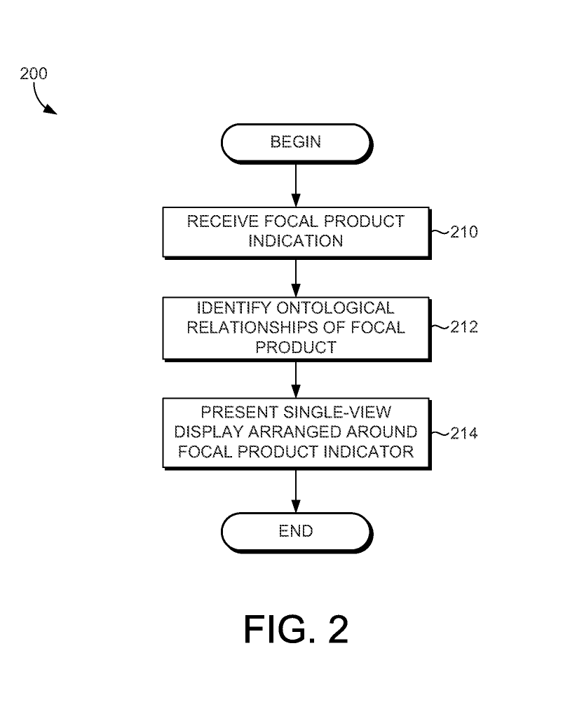

With reference to FIG. 2, a flow diagram is illustrated showing a method 200 for presenting related products in a single, mixed-view, in accordance with an embodiment of the present invention. As shown at block 210, an indication of a focal product (that is a product of interest to the user) is received, for instance, by receiving component 120 of the related-product display generating engine 112 of FIG. 1. A plurality of ontological relationships of the focal product is identified or determined, as indicated at block 212 (e.g., by ontological relationship identifying component 112 of the related-product display generating engine 112 of FIG. 1). Each of the plurality of ontological relationships includes one or more additional products associated therewith that are related to the focal product. A single-view display is subsequently presented having product indicators for at least a portion of the one or more additional products associated with at least two of the plurality of ontological relationships, as indicated at block 214. By way of example, the presented single-view display may be generated by the display generating component 124 of the related-product display generating engine 112 of FIG. 1 and presented on the display screen 118 of the end-user computing device 110.

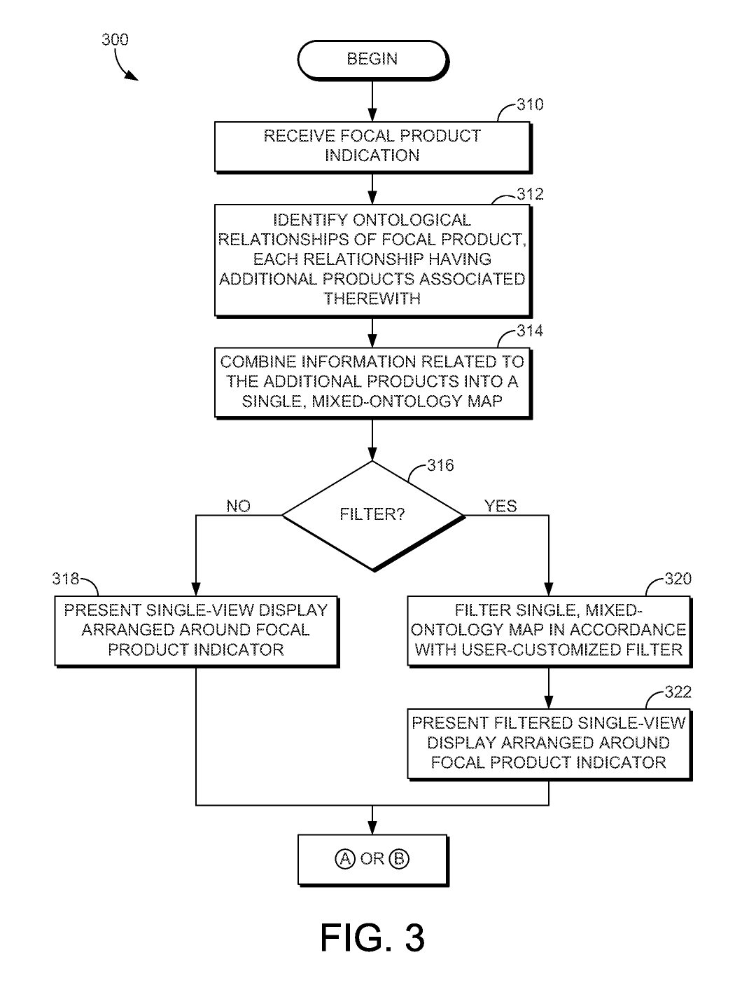

Turning now to FIG. 3, a flow diagram is illustrated showing a method 300 for presenting related products in a single, mixed-view, in accordance with an embodiment of the present invention. As shown at block 310, a focal product (that is, a product of interest to the user) is received, for instance, by receiving component 120 of the related-product display generating engine 112 of FIG. 1. A plurality of ontological relationship of the focal product is identified or determined, as indicated at block 312 (e.g., by ontological relationship identifying component 112 of the related-product display generating engine 112 of FIG. 1). Each of the plurality of ontological relationship includes one or more additional products associated therewith that are related to the focal product. As indicated at block 314, information related to the one or more additional products associated with each of the plurality of ontological relationship is assimilated and combined into a single, mixed-ontology map, for instance, utilizing mixed-ontology map generating component 126 of the related-product display generating engine 112 of FIG. 1.

Next, as indicated at block 316, it is determined whether or not a filter is to be applied to the information contained in the mixed-ontology map prior to presenting a single-view display. By way of example, such determination may be made utilizing filtering component 128 of the related-product display generating engine 112 of FIG. 1. Upon determining that no filter is to be applied, a single-view display is subsequently presented having product indicators for at least a portion of the one or more additional products associated with at least two of the plurality of ontological relationships, as indicated at block 318. By way of example, the presented single-view display may be generated by the display generating component 124 of the related-product display generating engine 112 of FIG. 1 and presented on the display screen 118 of the end-user computing device 110.

Alternatively, upon determining that a filter is to be applied, the information contained in the single, mixed-view ontology map is filtered (e.g., utilizing filtering component 128 of the related-product display generating engine 112 of FIG. 1) in accordance with any applicable filters, as indicated at block 320, and a filtered, single-view display is subsequently presented having product indicators for at least a portion of the one or more additional products associated with at least two of the plurality of ontological relationships, as indicated at block 320. By way of example, the presented filtered, single-view display may be generated by the display generating component 124 of the related-product display generating engine 112 of FIG. 1 and presented on the display screen 118 of the end-user computing device 110.

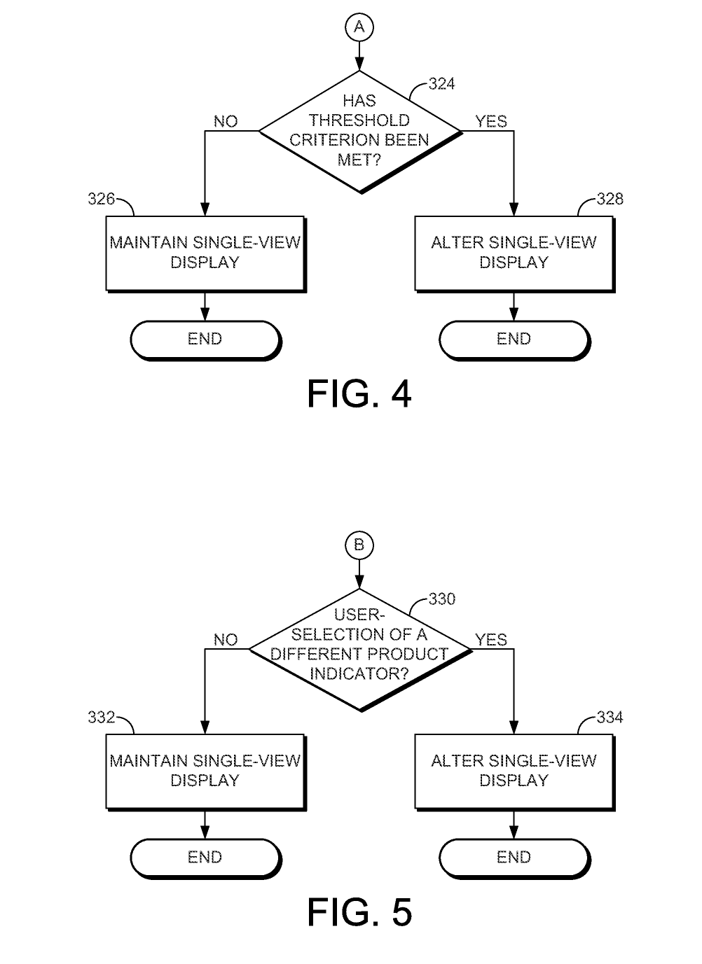

With reference to FIG. 4, a flow diagram is illustrated showing a method 400 for presenting related products in a single, mixed-view upon determining whether a particular threshold criterion has been met, in accordance with embodiments of the present invention. Upon completion of the method 300 shown in FIG. 3, it is determined whether a threshold criterion has been met that would cause alteration of the single-view display. This is indicated at block 324. If it is determined that no threshold criterion have been met, the single-view display presented at either blocks 318 or 322 of FIG. 3 is maintained, as indicated at block 326. If, however, it is determined that a threshold criterion has been met, the single-view display presented at either blocks 318 or 322 of FIG. 3 is changed or altered such that at least one of the presented product indicators on the single-view display is changed to a new product indicator, as shown at block 328. The new product indicator may be associated with a new product belonging to the same one of the plurality of ontological relationships as the product associated with the changed product indicator or a different of the plurality of ontological relationships. By way of example, the changed, single-view display may be generated by the display generating component 124 of the related-product display generating engine 112 of FIG. 1 and presented on the display screen 118 of the end-user computing device 110.

With reference to FIG. 5, a flow diagram is illustrated showing a method 500 for presenting related products in a single, mixed-view upon determining whether a user has selected a different product indicator, in accordance with embodiments of the present invention. Upon completion of the method 300 shown in FIG. 3, it is determined whether user-selection of a different product indicator has been received, for instance, by the receiving component 120 of the related-product display generating engine 112 of FIG. 1. This is indicated at block 330. Upon determining that no user-selection has been received, the single-view display presented at either blocks 318 or 322 of FIG. 3 is maintained, as indicated at block 332. If, however, it is determined that a user-selection of a different product indicator has been received, the single-view display presented at either blocks 318 or 322 of FIG. 3 is changed or altered such that the selected different product indicator becomes the focal product and a plurality of additional product indicators are arranged there around. This is indicated at block 334. By way of example, the changed, single-view display may be generated by the display generating component 124 of the related-product display generating engine 112 of FIG. 1 and presented on the display screen 118 of the end-user computing device 110.

Turning now to FIG. 6, a screen display showing an exemplary user-interface 600 for use in presenting related products in a single, mixed-view, in accordance with an embodiment of the present invention is illustrated. The user-interface 600 includes a focal product indicator display area 610 configured for presenting a product indicator for a focal product, and a related product indicator display area 612 configured for presenting product indicators for at least a portion of additional products identified as associated with a plurality of ontology relationships of the focal product. The related product indicator display area 612 is arranged around the focal product indicator display area 610.

Also shown is a user-selectable filter display area 614 configured for receiving a user selection indicating which of the plurality of ontology relationships of the focal product indicators are to be displayed and/or in what proportion. It will be understood and appreciated that the illustrated user-customizable filter area 614 is merely by way of example as many different configurations of such functionality may be present, whether in association with or separate from the focal product indicator display area 610 and related product indicator display area 612.

### Exemplary Operating Environment

A first exemplary operating environment in which various aspects of the present invention may be implemented is described below in order to provide a general context for various aspects of the present invention. Referring to FIG. 7 in particular, an exemplary operating environment for implementing embodiments of the present invention is shown and designated generally as computing device 700. The computing device 400 is but one example of a suitable computing environment and is not intended to suggest any limitation as to the scope of use or functionality of the invention. Neither should the computing device 700 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 7, the computing device 700 includes a bus 710 that directly or indirectly couples the following devices: memory 7 one or more processors 714, one or more presentation components 716, input/output ports 718, input/output components 720, and an illustrative power supply 722. The bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 7 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

The computing device 700 typically includes a variety of computer-readable media. Compute-readable media can be any available media that can be accessed by computing device 700 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 712 includes computer-storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

The I/O ports 718 allow computing device 700 to be logically coupled to other devices including the I/O components 720, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### CONCLUSION

As can be seen, embodiments of the present invention provide systems, methods, and computer-readable media for, among other things systems, methods, and computer-readable media for, among other things, presenting related products in a single, mixed-view. While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 200 of FIG. 2, the method 300 of FIG. 3, the method 400 of FIG. 4 and the method 500 of FIG. 5 are not meant to limit the scope of embodiments of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

The invention claimed is:

1. Computer storage media having computer-executable instructions embodied thereon that, when executed, perform a method for presenting related products in a single, mixed-view, the method comprising:
receiving an indication of a focal product;
identifying a plurality of ontological relationships of the focal product, each of the plurality of ontological relationships having one or more additional products associated therewith; and
presenting a single-view display having product indicators for at least a portion of the one or more additional products associated with at least two of the plurality of ontological relationships arranged around an indicator of the focal product.

2. The computer storage media of claim 1,
wherein the method further comprises combining information related to the one or more additional products associated with each of the plurality of ontological relationships into a single, mixed-ontology map,
and wherein presenting a single-view display comprises presenting at least a portion of the information contained in the single, mixed-ontology map in the single-view display.

3. The computer storage media of claim 1, wherein upon combining the information related to the one or more additional products associated with each of the plurality of ontological relationships into a single, mixed-ontology map, an indication of the one of the plurality of ontological relationships with which each of the one or more additional products is associated is preserved.

4. The computer storage media of claim 1, wherein the product indicators for the at least a portion of the one or more additional products presented in the single-view display include one or more of an iconic indicator, a product-label indicator, or an ontology-relationship indicator.

5. The computer storage media of claim 1, wherein the method further comprises providing a user-customizable filter that permits a user to control to which of the plurality of ontological relationship indicators of presented additional products are associated.

6. The computer storage media of claim 5, wherein the user-customizable filter further permits a user to control a proportion of indicators of additional products associated with one or more of the plurality of ontological relationships that are presented.

7. The computer storage media of claim 1, wherein the user-customizable filter is at least one of presented in association with the single-view display and presented as a user-preference selection independent of the single-view display.

8. The computer storage media of claim 1, wherein the method further comprises:
determining that a threshold criterion has been met; and
upon determining that the threshold criterion has been met, changing at least one of the presented product indicators on the single-view display to a new product indicator, wherein the new product indicator is associated with a new product belonging to the same one of the plurality of ontological relationships as the product associated with the changed product indicator.

9. The computer storage media of claim 1, wherein the method further comprises:
determining that a threshold criterion has been met; and
upon determining that the threshold criterion has been met, changing at least one of the presented product indicators on the single-view display to a new product indicator, wherein the new product indicator is associated with a new product belonging to a different one of the plurality of ontological relationships as the product associated with the changed product indicator.

10. The computer storage media of claim 1, wherein the method further comprises:
receiving a user-selection of one of the additional-product product indicators;
identifying a second plurality of ontological relationships of a product associated with the user-selected additional product indicator, each of the second plurality of ontological relationships having one or more additional products associated therewith; and
changing the single-view display such that product indicators for at least a portion of the one or more additional products associated with at least two of the second plurality of ontological relationships are arranged around the user-selected additional product indicator.

11. A system for presenting related products in a single, mixed-view, the system, comprising:
a computing device associated with one or more processors and one or more computer storage media;
a data store coupled with the computing device; and
a related-product display generating engine that
receives an indication of a focal product,
identifies a plurality of ontological relationships of the focal product, each of the plurality of ontological relationships having one or more additional products associated therewith, and
presents a single-view display having product indicators for at least a portion of the one or more additional products associated with at least two of the plurality of ontological relationships arranged around an indicator of the focal product.

12. The system of claim 11, wherein the related-product display generating engine further combines information related to the one or more additional products associated with each of the plurality of ontological relationships into a single, mixed-ontology map.

13. The system of claim 11, wherein the related-product display generating engine further provides a user-customizable filter that permits a user to control to which of the plurality of ontological relationships indicators of presented additional products are associated.

14. The system of claim 11, wherein the related-product display generating engine further provides a user-customizable filter that permits a user to control a proportion of indicators of additional products associated with one or more of the plurality of ontological relationships that are presented.

15. The system of claim 11, wherein the related-product display generating engine further determines whether a threshold criterion has been met and, upon determining that the threshold criterion has been met, changes at least one of the presented product indicators on the single-view display to a new product indicator.

16. The system of claim 15, wherein the new product indicator is associated with a new product belonging to the same one of the plurality of ontological relationships as the product associated with the changed product indicator.

17. The system of claim 15, wherein the new product indicator is associated with a new product belonging to a different one of the plurality of ontological relationships as the product associated with the changed product indicator.

18. The system of claim 11, wherein the related-product display generating engine further
receives a user-selection of one of the additional-product product indicators,
identifies a second plurality of ontological relationships of a product associated with the user-selected additional product indicator, each of the second plurality of ontological relationships having one or more additional products associated therewith, and
changes the single-view display such that the product indicators for at least a portion of the one or more additional products associated with at least two of the second plurality of ontological relationships are arranged around the user-selected additional product indicator.

19. Computer storage media having computer-executable instructions embodied thereon that, when executed, cause a computing device to present related products in a single, mixed-view, user-interface, the user-interface comprising:
a focal product indicator display area that presents a product indicator for a focal product; and
a related product indicator display area that presents product indicators for at least a portion of additional products identified as associated with a plurality of ontological relationships of the focal product, the related product indicator display area being arranged around the focal product indicator display area.

20. The computer storage media of claim 19, wherein the user-interface further comprises a user-selectable filter display area that receives a user selection indicating for which of the plurality of ontological relationships of the focal product, related product indicators are to be displayed and/or in what proportion.
